(19) United States
(12) Patent Application Publication
(10) Pub. No.: US 2019/0227987 A1
(43) Pub. Date: Jul. 25, 2019

(54) Data-Oriented Architecture (DOA) System

(71) Applicant: INTELLIGENT BUSINESS SOFTWARE (BEIJING) CO.,LTD, Beijing (CN)

(72) Inventors: Jianmin HE, Beijing (CN); Donghai LI, Beijing (CN)

(21) Appl. No.: 16/326,396

(22) PCT Filed: Jul. 24, 2017
(86) PCT No.: PCT/CN2017/094114

§ 371 Date: Feb. 19, 2019

(30) Foreign Application Priority Data
Aug. 19, 2016 (CN) 201610694438.3

(51) Int. Cl. G06F 16/13; H04L 29/08; G06F 16/11

(52) U.S. Cl. CPC G06F 16/13; G06F 16/113; H04L 67/2819

(57) ABSTRACT

Embodiments of the present invention relate to a data-oriented architecture (DOA) system comprising a data resource pool, which includes multiple data management modules, for storing data, a management center which includes an interface management module and multiple data interfaces, and each data interface corresponds to one data management module, wherein the interface management module is configured to configure the corresponding data interface for the data management modules, and get routing information of a requested data according to a data request information, the data request information includes attribute information of an application which initiates the data request information, the data interface is configured to obtain the requested data stored in the data management modules according to the routing information, compile and process the requested data to obtain data of a data structure that supported by the application according to the attribute information, and a DOA resource bus, connected to the data management modules via the data interface, for transferring the data obtained by compiling and processing to the application.

The present invention claims priority to the application 201610694438.3 entitled “data-oriented architecture (DOA) system”, which is submitted to National Intellectual Property Administration, PRC on Aug. 19, 2016.

### TECHNICAL FIELD

The present invention relates to the technical field of computer, in particular to a data-oriented architecture system.

### BACKGROUND

In recent years, service-oriented architecture (SOA) has been applied widely. This SOA uses the application program function as a service and sends it to end user or other service. The SOA further performs distributed deploy, combination and utilization of the loosely-coupled coarse-grained application component based on the requirement via network. And the service layer which could be invoked by the application directly, is the foundation of SOA. Therefore, the SOA could control the human dependence between the system and the software agent effectively.

However, in the age of big data, because of the limitations of the architecture, the long-lived issues in the field of information technology are increasingly prominent, the information among the systems are difficult to share, the functions of the already constructed system are hard to expand, the affair of the massive, heterogeneous, multi-source, dynamic, real-time changed and explosively growing big data are not easy to manage, analyze and mine, the process for developing a business-oriented software engineering is complicated and difficult to be maintained, and the life cycle of the software engineering is short, the problem of information security relating to national security, social stability, corporate interests and personal privacy is increasingly prominent, within the open network environment, the benefit of the data provider couldn't be protected, and so on. Even the loosely-couple provided by the SOA system couldn't meet the need of the big data era.

### SUMMARY OF THE INVENTION

The present invention provides a data-oriented architecture (DOA) system, through a management center the data of the system resource pool is completely decoupled in order to share the data. And the application invokes the corresponding data from data management modules directly via an interface management module when the application calls the data, so that the different function application could be realized, and the extension of the system function wouldn't be limited by the coupling relationship among the traditional data, and the maintenance cost is reduced, the extension is developed.

The embodiment of invention provides a data-oriented architecture system, and the system comprises:

a data resource pool, which includes multiple data management modules, for storing data,

a management center which includes an interface management module and multiple data interfaces, and each data interface corresponds to one data management module,

Wherein the interface management module is configured to configure the corresponding data interface for the data management modules, and get routing information of a requested data according to a data request information, the data request information includes attribute information of an application which initiates the data request information,

the data interface is configured to obtain the requested data stored in the data management modules according to the routing information, compile and process the requested data to obtain data of a data structure that supported by the application according to the attribute information,

and a DOA resource bus, connected to the data management modules via the data interface, for transferring the data obtained by compiling and processing to the application.

Preferred, the management center further comprises a data register center, for creating a data storage logic of the data resource pool.

Further preferred, the interface management module is connected with the data register center,

the interface management module recognizes the data to be stored which is transferred from a DOA resource bus,

the interface management module obtains the data storage logic from the data register center, and generates the routing information of the data to be stored according to the data storage logic,

the interface management module determines a first data interface, for capturing the data to be stored, according to the routing information,

the first data interface obtains the data to be stored from the DOA resource bus, is encapsulated into data with standardized data structure and sent to the data management module connected to the first data interface for storage.

Preferred, the management center further comprises a data authentication center, for doing authentication management for data,

the authentication management comprises data security attribute definition, data validity identification, data access authority definition, user authorization certification, application authorization and user authorization.

Preferred, the management center further comprises a data abnormal control center, for processing the data consistency of the data stored in the data management modules.

Preferred, the management center further comprises an application interface unit, for providing an application-oriented interface.

Further Preferred, the application interface unit is connected with the interface management module,

the application interface unit is configured to receive the data request information from the application, and sends the data request information to the interface management module.

Preferred, the interface management module is further configured to capture an on-line information of the data management modules of the DOA system.

Preferred, the interface management module is further configured to capture an off-line information of the data management modules of the DOA system.

The embodiment of invention provides a data-oriented architecture system, the data of the system resource pool is decoupled completely to share the data, And the application invokes the corresponding data from the data management modules directly via the interface management module when the application calls the data, so that the different function application could be realized, and the extension of the system function wouldn't be limited by the coupling relationship among the traditional data, and the maintenance cost is reduced, the extension is developed.

### BRIEF DESCRIPTION OF THE DRAWINGS

FIG. 1 is a schematic drawing illustrating a data-oriented architecture system according to the present invention.

### DETAILED DESCRIPTION

In order to make the purpose, the technical scheme and the advantage of the present invention more clear, the present invention is further described in detail in combination with the figures,

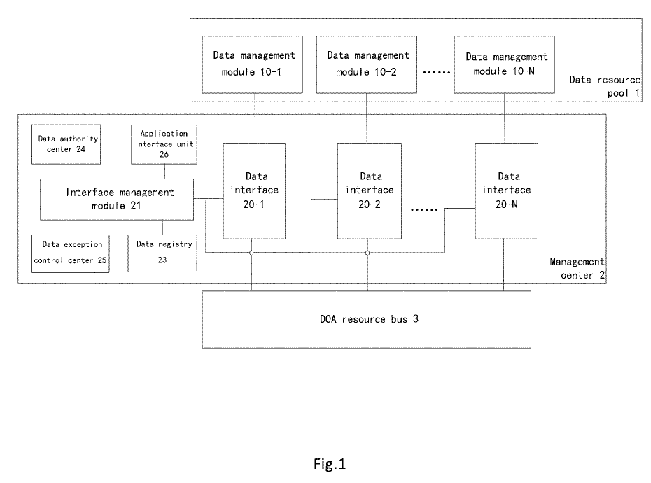

The data-oriented architecture (DOA) system provided in the embodiment of the present invention is described in detail below with respect to FIG. 1.

As shown in FIG. 1, the DOA system of the embodiment comprises:

A data resource pool 1 comprises multiple data management modules 10-1, 10-2 . . . 10-N, and the data resource pool 1 is configured to store the data which include meta-data and business data. Each data management module may be one or a group of data storage servers, or a data storage server cluster.

A management center 2 comprises an interface management module 21 and multiple data interfaces 20-1, 20-2 . . . 20-N, and each data interface corresponds to one data management module.

Wherein, the interface management module 21 is configured to configure the corresponding data interface for the data management modules, and get routing information of the requested data according to data request information, when the application calls data, the data request information includes attribute information of the application which initiates the data request information.

In a specifically embodiment, the routing information is sent to the corresponding data interface by the interface management module 21, for example, if the routing information points to the data management module 10-2, the routing information is sent to the data interface 20-2.

The data interface is used to obtain the requested data stored in the data management modules according to the routing information, and compile and process the requested data to obtain data with the data structure supported by the application which initiate the data request information according to the attribute information of the application.

DOA resource bus 3, connects with the data management modules via the data interface, is configured to transfer the data obtained by compiling and processing to the application.

Therefore, the isolation between the application and data is realized by the management center 2 virtually, no matter what is the data structure supported by the application, the stored data is based on the data structure of a standardized language, so that the data stored in system could be shared and used by different applications. There is no coupling relationship available among the data, and the data are discrete decoupling, so that the storage of data would not be effected while introducing or reducing the application in the system.

In case that the data storage space needs to be increased in the system, and a new data management module is introduced in the system, the interface management module 21 capture the on-line information of the data management module of the DOA system.

For example, when the data management module 10-2 is on-line in the system, and an on-line prompt message is sent to the DOA resource bus 3, the interface management module 21 obtains the on-line prompt message transferred by the DOA resource bus 3, so that the on-line information of the data management module 10-2 is obtained.

The interface management module 21 configures the data interface to the data management module 10-2, and the interface management module 21 is configured with the data interface 20-2.

In case that one data management module occurs malfunctions or other conditions which lead to off-line in the system, the interface management module 21 obtains the off-line information of the data management module in the DOA system.

In a concrete implementation, the interface management module 21 polls and sends information to each data management module in the system regularly, and receives feedback information from each data management module, if the feedback information from the data management module is not received in the setting time, the data management module is determined to be off-line. Preferred, in the setting time, the interface management module 21 sends the information to the data management module repeatedly.

When determining that one data management module is off-line, the interface management module 21 generates and records failure information of the data stored in the data management module.

Additionally, the management center 2 further comprises a data register center 23, a data authority center 24, a data exception control center 25 and an application interface unit 26. These modules are described in turns below.

The data register center 23 is configured to create a data storage logic of the data resource pool.

The interface management module 21 is connected to the data register center 23.

When the data is stored into the data management modules, the interface management module 21 recognizes the data to be stored transmitted on the DOA resource bus 3, the interface management module 21 obtains the data storage logic from the data register center 23, and generates the routing information of the data to be stored according to the data storage logic.

In multiple data interfaces, a first data interface which is configured to capture the data to be stored, is determined according to the routing information, the first data interface obtains the data to be stored from the DOA resource bus 3, packages the data as data of standardized data structure, and sends the data to the data management module which is connected with the first data interface, to store.

The data authority center 24 is configured to do the authority management for the data.

The scope of the authority management includes data security attribute definition, data validity identification, data access authority definition, user authority certification, application authorization and user authorization.

The manners for authentication management of the data could be completed while the data are written to the data management modules, and could process the data of the data management modules directly.

The data exception control center 25 is configured to process the data consistency of the data stored in the data management modules.

Wherein, the data exception control center is configured to monitor various abnormal conditions, and carries out corresponding abnormal condition operation process to the abnormal conditions according to a setting operation mechanism.

Wherein, the abnormal condition operation process comprises issues abnormal condition signal, replaces the abnormal data with the preliminary data and requests the data register center 23 to refresh corresponding information and so on.

The application interface unit 26 is configured to provide application-oriented interfaces.

The application interface unit 26 is connected with the interface management module 21, receives the data request information from the application, and sends the data request information to the interface management module 21.

The embodiment of invention provides a data-oriented architecture system, the data of the system resource pool is decoupled completely to share the data. And the application invokes the corresponding data from the data management modules directly via the interface management module when the application calls the data, so that the different function application could be realized, and the extension of the system function wouldn't be limited by the coupling relationship among the traditional data, and the maintenance cost is reduced, the extension is developed.

Those skilled in the art can understand the units and algorithm steps of respective examples described in combination with the embodiments of the specification can be implemented by electronic hardware, computer software or the combination of both, in order to explain the interchangeability of the hardware and the software, the constitution and steps of the respective examples are described generally according to the function in the above description. Whether to implement the functions in hardware or software is application-specific. Professional technicians may adopt different methods to realize the described functions in each specific application, which, however, should be considered as falling within the scope of the present invention.

In combination with the embodiments herein, steps of the method or algorithm described may be directly implemented using hardware, a software module executed by a processor, or the combination thereof. The software module can be embedded in RAM, internal memory, ROM, electrically programmable ROM, electrically erasable programmable ROM, register, hard disk, removable disk, CD-ROM, or storage medium of any other form known in the field.

The embodiments mentioned above have detailed described the purpose, the technical scheme and the advantage of the present invention, it is to be understood that the above is only preferred embodiments of the present invention, but does not limit the protective scope of the present invention, any modification, equivalent replacement or improvement made under the spirit and principles of this invention is included in the protection scope of this invention.

What is claimed is:

1. A data-oriented architecture (DOA) system, comprising:
a data resource pool, which includes multiple data management modules, for storing data,
a management center which includes an interface management module and multiple data interfaces, and each data interface corresponds to one data management module,
Wherein the interface management module is configured to configure the corresponding data interface for the data management modules, and get routing information of a requested data according to a data request information, the data request information includes attribute information of an application which initiates the data request information,
the data interface is configured to obtain the requested data stored in the data management modules according to the routing information, compile and process the requested data to obtain data of a data structure that supported by the application according to the attribute information,
and a DOA resource bus, connected to the data management modules via the data interface, for transferring the data obtained by compiling and processing to the application.

2. The DOA system of claim 1, wherein the management center further comprises a data register center, for creating a data storage logic of the data resource pool.

3. The DOA system of claim 2, wherein the interface management module is connected with the data register center,
the interface management module recognizes the data to be stored which is transferred from the DOA resource bus,
The interface management module obtains the data storage logic from the data register center, and generates the routing information of the data to be stored according to the data storage logic,
The interface management module determines a first data interface, for capturing the data to be stored, according to the routing information,
The first data interface obtains the data to be stored from the DOA resource bus, is encapsulated into data with standardized data structure and sent to the data management module connected to the first data interface for storage.

4. The DOA system of claim 1, wherein the management center further comprises a data authentication center, for doing authentication management for data,
the authentication management comprises data security attribute definition, data validity identification, data access authority definition, user authorization certification, application authorization and user authorization.

5. The DOA system of claim 1, wherein the management center further comprises a data abnormal control center, for processing the data consistency of the data stored in the data management modules.

6. The DOA system of claim 1, wherein the management center further comprises an application interface unit, for providing an application-oriented interface.

7. The DOA system of claim 6, wherein the application interface unit is connected with the interface management module,
the application interface unit is configured to receive the data request information from the application, and sends the data request information to the interface management module.

8. The DOA system of claim 1, wherein the interface management module is further configured to capture an on-line information of the data management modules of the DOA system.

9. The DOA system of claim 1, wherein the interface management module is further configured to capture an off-line information of the data management modules of the DOA system.
